(19) United States
(12) Patent Application Publication
(10) Pub. No.: US 2026/0351633 A1
(43) Pub. Date: Nov. 5, 2026

(54) HIGH EFFICIENCY FUEL CELL SYSTEM

(71) Applicant: ACROLABS INC., Seongnam-si Gyeonggi-d0 (KR)

(72) Inventors: Dae Han PARK, Seoul (KR); Hyung Mok CHO, Gunpo-si (KR); Ho Suk KIM, Seongnam-si (KR)

(73) Assignee: ACROLABS INC., Seongnam-si Gyeonggi-d0 (KR)

(21) Appl. No.: 19/098,451

(22) Filed: Apr. 2, 2025

(30) Foreign Application Priority Data
Nov. 20, 2024 (KR) 10-2024-0166579

(51) Int. Cl. H01M 8/0267; H01M 8/04119; H01M 8/04492; H01M 8/0612

(52) U.S. Cl. CPC H01M 8/0267; H01M 8/04134; H01M 8/04492; H01M 8/0618

(57) ABSTRACT

There is provided a fuel cell system including a fuel cell stack which generates power by an electrochemical reaction of hydrogen contained in hydrogen-containing gas and oxygen contained in air and is cooled by cooling water, a reformer configured to react a hydrocarbon-based raw material with water vapor to generate reformed gas, a selective oxidation reactor which removes carbon monoxide from the reformed gas to generate the hydrogen-containing gas and is cooled by cooling water, a membrane humidifier configured to receive at least some cooling water discharged from the fuel cell stack and humidify air supplied to the fuel cell stack, a cooling water tank configured to store the cooling water, and a controller configured to control humidification amounts of the hydrogen-containing gas and the air, which are supplied to the fuel cell stack.

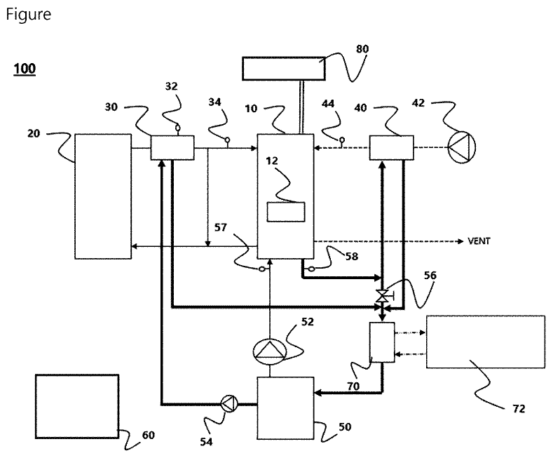

### CROSS-REFERENCE TO RELATED APPLICATION

This application claims priority to and the benefit of Korean Patent Application No. 10-2024-0166579, filed on Nov. 20, 2024, the disclosure of which is incorporated herein by reference in its entirety.

### BACKGROUND

### 1. Field of the Invention

The present invention relates to a high efficiency fuel cell system.

### 2. Discussion of Related Art

A fuel cell is an energy conversion device for converting chemical energy into electrical energy through an electrochemical reaction of hydrogen and oxygen.

A fuel cell system basically includes a fuel cell stack for producing electrical energy through an electrochemical reaction, and an inverter for converting produced DC electricity into AC electricity. In addition, the fuel cell system includes a reformer for reforming hydrocarbon-based fuel to produce hydrogen-containing gas when using hydrocarbon-based fuel (LNG, LPG, etc.) as fuel for a fuel cell.

Meanwhile, polymer electrolyte membrane fuel cells (PEMFCs) have advantages of a low operation temperature of about 60 to 80 °C, fast operation and response characteristics, excellent durability, and the like and thus are attracting attention as portable, vehicle, and home fuel cells.

Within these PEMFCs, it is necessary to manage a water content of a polymer electrolyte membrane to smoothly move hydrogen ions through the polymer electrolyte membrane, ensure stability of the electrolyte membrane and electrodes, and increase system efficiency. When there is too little moisture, ion conductivity can decrease and the performance of a fuel cell stack may be degraded, and when such a state persists, the polymer electrolyte membrane can shrink and crack. This can shorten the lifetime of the polymer electrolyte membrane and lead to fuel leakage. Conversely, when there is too much moisture, reaction gas cannot be properly supplied due to flooding, a reaction speed can decrease, and the output of the fuel cell can fluctuate rapidly, or an unstable operation state can be caused. Accordingly, reactants, that is, air and fuel gas, supplied to the fuel cell stack need to be humidified, and at the same time, water which is a byproduct of power generation should be removed to prevent the movement of the reactants from being restricted by water.

The air humidification is usually performed in a membrane humidifier, and conventional fuel cell systems use a method of supplying air (so-called cathode off-gas) discharged from a fuel cell stack to a membrane humidifier and humidifying external air. However, such a method has a problem in that the effect of heat supply is insignificant due to low specific heat of gas, it is difficult to supply sufficient moisture to the membrane humidifier, it is not possible to respond immediately to a change in the amount of air determined by a power generation output of a stack, and thus the operation efficiency and durability of the fuel cell stack are reduced.

### RELATED ART DOCUMENT

### Patent Document

(Patent Document 1) Korean Laid-Open Patent No. 10-2023-0166705

### SUMMARY OF THE INVENTION

The present invention is directed to providing a fuel cell system capable of securing efficient operation and stability of a fuel cell system regardless of a power generation output of a stack or an operation situation.

According to an aspect of the present invention, there is provided a fuel cell system including a fuel cell stack which generates power by an electrochemical reaction of hydrogen contained in hydrogen-containing gas and oxygen contained in air and is cooled by cooling water, a reformer configured to react a hydrocarbon-based raw material with water vapor to generate reformed gas, a selective oxidation reactor which removes carbon monoxide from the reformed gas to generate the hydrogen-containing gas and is cooled by cooling water, a membrane humidifier configured to receive at least some cooling water discharged from the fuel cell stack and humidify air supplied to the fuel cell stack, a cooling water tank configured to store the cooling water, and a controller configured to control humidification amounts of the hydrogen-containing gas and the air, which are supplied to the fuel cell stack.

The fuel cell system may further include a first pump configured to control a supply amount of cooling water supplied to the fuel cell stack, and a second pump configured to control a supply amount of cooling water supplied to the selective oxidation reactor.

The fuel cell system may further include a cooling water control valve configured to control a supply amount of cooling water supplied to the membrane humidifier from cooling water discharged from the fuel cell stack.

The controller may control the humidification amount of the hydrogen-containing gas by controlling a supply amount of cooling water supplied to the selective oxidation reactor.

The controller may control the supply amount of the cooling water supplied to the selective oxidation reactor so that an operation temperature of the selective oxidation reactor ranges from 90 to 130 °C and a temperature of the hydrogen-containing gas supplied to the fuel cell stack ranges from 60 to 70 °C.

### BRIEF DESCRIPTION OF THE DRAWINGS

The above matters and other objects, features, and advantages of the present invention will become more apparent to those of ordinary skill in the art by describing exemplary embodiments thereof in detail with reference to the accompanying drawings, in which:

The FIGURE is a schematic conceptual diagram for describing a fuel cell system according to one embodiment of the present invention.

### DETAILED DESCRIPTION OF EXEMPLARY EMBODIMENTS

Before providing a detailed description of the present invention, the terms or words used in the present specification and claims, which will be described below, should not be construed as limited to their usual or dictionary meanings and should be construed as possessing meanings and concepts that conform to the technical spirit of the present invention based on the principle that the inventor can appropriately define the concept of the terms to describe his or her own invention according to the best mode. Accordingly, since embodiments described in the present specification and configurations illustrated in the drawings are only the best exemplary embodiments of the present invention and do not represent all of the technical ideas of the present invention, it should be understood that there may be various equivalents and modifications capable of replacing them at the time of filing this application.

Throughout the present specification, when a certain portion is described as being “connected to” another portion, it includes not only a case in which the certain portion is “directly connected” to another portion, but also a case in which the certain portion is “electrically connected” to another portion with still another portion interposed therebetween.

Throughout the present specification, when a certain member is described as being located “on,” “above,” “on an upper end of,” “under,” “below,” or “on a lower end of” another member, it includes both a case in which the certain member is in contact with another member and a case in which still another member is present between the two members.

Throughout the present specification, when a certain portion is described as “including” certain elements, it means that the certain portion may further include other elements rather than precluding other elements unless specifically stated to the contrary.

Hereinafter, exemplary embodiments of the present invention will be described in detail by referencing the accompanying drawings. In this case, it should be noted that the same components in the accompanying drawings are denoted with the same reference numerals as often as possible. Detailed descriptions of well-known functions and components which can obscure the gist of the present invention are omitted. For the same reason, some components in the accompanying drawings are exaggerated, omitted, or schematically illustrated, and the size of each component does not entirely reflect the actual size thereof.

The FIGURE is a schematic conceptual diagram for describing a fuel cell system according to one embodiment of the present invention.

Referring to the FIGURE, a fuel cell system 100 according to one embodiment of the present invention includes a fuel cell stack 10 which generates power by an electrochemical reaction between hydrogen contained in hydrogen-containing gas and oxygen contained in air and is cooled by cooling water, a reformer 20 for reacting a hydrocarbon-based raw material and water vapor to generate reformed gas, a selective oxidation reactor 30 which generates the hydrogen-containing gas by removing carbon monoxide from the reformed gas and is cooled by cooling water, a membrane humidifier 40 for receiving at least some of the cooling water discharged from the fuel cell stack 10 and humidifying the air supplied to the fuel cell stack 10, a cooling water tank 50 for storing the cooling water, and a controller 60 for controlling humidification amounts of the hydrogen-containing gas and the air, which are supplied to the fuel cell stack 10.

The fuel cell stack 10 may be formed by stacking a plurality of unit cells including a membrane electrode assembly (MEA) and a pair of separators disposed at both sides of the MEA.

Hydrogen-containing gas is supplied to an anode of the fuel cell stack 10, oxidizer gas is supplied to a cathode, and the fuel cell stack 10 generates power by an electrochemical reaction of hydrogen contained in the hydrogen-containing gas and oxygen contained in the oxidizer gas.

Unreacted anode off-gas is discharged from the anode of the fuel cell stack 10, and unreacted cathode off-gas is discharged from the cathode thereof. The unreacted anode off-gas may be supplied to a burner of the reformer 20 to be described below and used as fuel along with air.

According to one example, the fuel cell system according to the present invention may further include a voltage monitoring device 12 for measuring an operation voltage of the fuel cell stack 10.

According to one example, the fuel cell system according to the present invention may include a hydrogen-containing gas supply pipe, an anode off-gas discharge pipe, and a bypass pipe connecting the hydrogen-containing gas supply pipe to the anode off-gas discharge pipe, and these pipes are indicated by dotted lines in the FIGURE. A first shutoff valve (not illustrated) for supplying hydrogen-containing gas to the bypass pipe or shutting off the supply of the hydrogen-containing gas to the bypass pipe may be installed on the bypass pipe, a second shutoff valve (not illustrated) for supplying hydrogen-containing gas to the fuel cell stack 10 or shutting off the supply of the hydrogen-containing gas to the fuel cell stack 10 may be installed on the hydrogen-containing gas supply pipe, and a third shutoff valve (not illustrated) for shutting off the supply of hydrogen-containing gas which has passed through the bypass pipe to the fuel cell stack 10 may be installed on the anode off-gas discharge pipe.

During operation of the fuel cell system, since the temperature of the reformer 20 and the selective oxidation reactor 30, which will be described below, is low and thus hydrogen-containing gas with a relatively high carbon monoxide concentration may be discharged, the second and third shutoff valves may be closed and the first shutoff valve may be opened so that the hydrogen-containing gas with a relatively high carbon monoxide concentration may be supplied to the burner of the reformer to be described below and used as a heat source. Thereafter, when the reformer 20 and the selective oxidation reactor 30 are maintained at an appropriate temperature so that the hydrogen-containing gas with a low carbon monoxide concentration is discharged, the first shutoff valve may be closed and the second and third shutoff valves may be opened so that the fuel cell system operates normally.

The reformer 20 may include a reforming reactor (not illustrated), a water gas conversion reactor (not illustrated), and a burner (not illustrated).

The reforming reactor generates reformed gas from a mixed gas of a hydrocarbon-based raw material and steam by a reforming reaction according to Formula 1 below.

CH₄+H₂O→3H₂+CO [Formula 1]

The water gas conversion reactor primarily removes carbon monoxide contained in the reformed gas through a reaction according to Formula 2 below and generates reformed gas with concentrated hydrogen.

CO+H₂O→H₂+CO₂ [Formula 2]

The reforming reaction in the reforming reactor is an endothermic reaction, and since the reforming reaction is performed at a high temperature of 600 to 700 °C, it is necessary to supply external reaction heat. Such reaction heat may be obtained from the burner disposed adjacent to the reforming reactor.

The burner generates high-temperature heat by burning fuel gas such as a hydrocarbon-based raw material (LNG, LPG, etc.), unreacted anode off-gas discharged from the anode of the fuel cell stack 10, or the like, and the temperature of the burner is maintained at about 600 to 1000 °C due to the burning of the fuel gas.

The selective oxidation reactor 30 primarily removes carbon monoxide and supplies air to the reformed gas with concentrated hydrogen to generate hydrogen-containing gas in which carbon monoxide is secondarily removed through a reaction according to Formula 3 below.

2CO+O₂→2CO₂ [Formula 3]

Since a conversion reaction of carbon monoxide into carbon dioxide, which occurs in the selective oxidation reactor 30, is performed at about 100 °C and is a very temperature-sensitive reaction, carbon monoxide removal efficiency can be significantly reduced depending on a temperature. Accordingly, cooling water is supplied to the selective oxidation reactor 30 to maintain a constant temperature range.

According to one example, the fuel cell system according to the present invention may further include a selective oxidation reactor temperature sensor 32 for measuring an operation temperature of the selective oxidation reactor 30.

According to one example, the fuel cell system according to the present invention may further include an anode temperature inlet sensor 34 for measuring the temperature of hydrogen-containing gas supplied to the anode of the fuel cell stack 10.

According to one example, the fuel cell system according to the present invention may include an air supply pipe and a cathode off-gas discharge pipe, and these pipes are indicated by long dashed lines in the FIGURE.

In order for the fuel cell stack 10 to operate normally, an electrolyte membrane of the MEA needs to be maintained at a certain humidity or greater, and thus wet air with high humidity is supplied through the membrane humidifier 40 to the cathode of the fuel cell stack 10.

The membrane humidifier 40 receives at least some of the cooling water discharged from the fuel cell stack 10 and humidifies the air supplied to the fuel cell stack.

Conventional fuel cell systems use a method of supplying cathode off-gas discharged from a fuel cell stack to a membrane humidifier to humidify external air (so-called a gas-to-gas method). However, such a method has a problem in that the effect of heat supply is insignificant due to low specific heat of gas, it is difficult to supply sufficient moisture to the membrane humidifier, and it is not possible to respond immediately to a change in the amount of air determined by a power generation output of a stack, thereby reducing operation efficiency and durability of the fuel cell stack.

In contrast, in the present invention, by supplying cooling water as a medium for supplying heat and moisture to the membrane humidifier 40 (so-called a water-to-gas method), it is possible to easily control the hydrogen-containing gas and the amount of the humidification of air supplied to the fuel cell stack according to the power generation output or operation situation of the fuel cell stack, thereby securing efficient operation and stability of the fuel cell system regardless of the power generation output or operation situation of the fuel cell stack.

Meanwhile, when using the fuel cell system, there are cases of the fuel cell system being used at a load lower than a load of a design capacity. A case of the fuel cell system being used in a state in which a load consuming electricity is lower than a design value (e.g., 75% or 50%) is referred to as a partial load operation. When such a partial load operation is performed, it is generally difficult to maintain the humidification performance of the membrane humidifier in the best state, and the membrane humidifier manufactured with the largest amount of humidification at a flow rate of the rated capacity may have lower humidification efficiency when the flow rate decreases. However, in the present invention, since the flow rate of the cooling water may be controlled, there is an advantage that the humidification performance of the membrane humidifier can be maintained in the best state under any condition.

In addition, the present invention is characterized in that, when cooling water is supplied as a medium for supplying heat and moisture to the membrane humidifier 40, cooling water discharged from the cooling water tank 50 is not used directly, but the cooling water which has passed through the fuel cell stack 10 is used, and thus there is an additional advantage in that the humidification amount of the membrane humidifier can be controlled to be in a broader range. When the cooling water discharged from the cooling water tank 50 is supplied to the membrane humidifier 40, the temperature of the wet air supplied to the cathode of the fuel cell stack 10 cannot be higher than or equal to the cooling water inlet temperature, and as a result, flooding caused by too much moisture in the wet air can be prevented, but degradation of performance of the fuel cell stack, cracking of the polymer electrolyte membrane, etc., which are caused by too little moisture in the wet air, cannot be resolved. However, in the present invention, by supplying the high-temperature cooling water, which has passed through the fuel cell stack 10, to the membrane humidifier 40, the temperature of the wet air supplied to the cathode of the fuel cell stack 10 may be controlled starting from the cooling water inlet temperature to the cooling water outlet temperature by controlling the flow rate of the cooling water, and as a result, flooding caused by too much moisture in the wet air can be prevented, and degradation of performance of the fuel cell stack, cracking of the polymer electrolyte membrane, etc., which are caused by too little moisture in the wet air, can be resolved.

According to one example, the fuel cell system of the present invention may further include an air pump 42 for controlling the amount of air supplied to the cathode of the fuel cell stack 10.

According to one example, the fuel cell system of the present invention may further include a cathode inlet temperature sensor 44 for measuring the temperature of the air supplied to the cathode of the fuel cell stack 10.

According to one example, the fuel cell system of the present invention may include an inverter 80 for converting produced DC electricity into AC electricity.

A cooling water unit serves to decrease the temperature of various components included in the fuel cell system and may be composed of the cooling water tank 50, various types of pumps for controlling the supply amount of the cooling water, various types of conduits for providing a circulation path between the cooling water tank 50 and the cooling water, and various types of sensors for measuring the temperature, flow rate, and the like of the cooling water.

According to one example, the cooling water unit includes the cooling water tank 50, a first cooling water supply pipe for supplying cooling water from the cooling water tank 50 to the fuel cell stack 10, a first cooling water collecting pipe for collecting cooling water discharged from the fuel cell stack 10 in the cooling water tank 50, a second cooling water supply pipe for supplying cooling water from the cooling water tank 50 to the selective oxidation reactor 30, a second cooling water collecting pipe for collecting cooling water discharged from the selective oxidation reactor 30 in the cooling water tank 50, a third cooling water supply pipe branched from the first cooling water collecting pipe to supply cooling water to the membrane humidifier 40, a third cooling water collecting pipe for collecting cooling water discharged from the membrane humidifier 40 in the cooling water tank 50, a first pump 52 provided on the first cooling water supply pipe to control the supply amount of cooling water supplied to the fuel cell stack 10, a second pump 54 provided on the second cooling water supply pipe to control the supply amount of cooling water supplied to the selective oxidation reactor 30, a cooling water control valve 56 for controlling the supply amount of cooling water supplied to the membrane humidifier 40 from the cooling water discharged from the fuel cell stack 10, a cooling water inlet temperature sensor 57 provided on the first cooling water supply pipe to measure the temperature of the cooling water supplied to the fuel cell stack 10, and a cooling water outlet temperature sensor 58 provided on the first cooling water collecting pipe to measure the temperature of the cooling water discharged from the fuel cell stack 10.

According to one example, the third cooling water supply pipe may be branched from a first point of a merging pipe, and the third cooling water collecting pipe may be merged with the first cooling water collecting pipe at a second point positioned behind the first point in a flowing direction of the cooling water.

According to one example, one end of the second cooling water collecting pipe may be connected to the selective oxidation reactor 30, and the other end may be connected to the first cooling water collecting pipe at the second point positioned behind the first point in the flowing direction of the cooling water and collected in the cooling water tank 50.

According to one example, the fuel cell system 100 according to the present invention may further include a heat exchanger 70 provided behind the second point in the flowing direction of the cooling water. In the heat exchanger 70, high-temperature cooling water flowing through the merging pipe and low-temperature cooling water circulating between the heat exchanger 70 and a heat collecting device 72 are heat-exchanged, and through such heat exchange, the temperature of the cooling water stored in the cooling water tank 50 can be maintained at a level suitable for collecting waste heat of the fuel cell system 100.

The controller 60 controls the humidification amounts of the hydrogen-containing gas and the air, which are supplied to the fuel cell stack 10 by controlling the operation of one or more of the first pump 52, the second pump 54, and the cooling water control valve 56.

According to one example, the controller 60 may receive measured temperature and stack voltage values in real time from the selective oxidation reactor temperature sensor 32, the anode inlet temperature sensor 34, the cathode inlet temperature sensor 44, the cooling water inlet temperature sensor 57, the cooling water outlet temperature sensor 58, and the voltage monitoring device 12, and based on the measured temperature and stack voltage values, control the operation of one or more of the first pump 52, the second pump 54, and the cooling water control valve 56 in real time, thereby effectively controlling the humidification amount of the hydrogen-containing gas and the air supplied to the fuel cell stack 10.

In the fuel cell system according to the present invention, real time humidification of the cathode gas can be carried out as follows.

First, a stack inlet temperature is measured through the cooling water inlet temperature sensor 57. As the result of the measurement, when the stack inlet temperature differs from a target temperature, the flow rate of the cooling water flowing into the fuel cell stack 10 is controlled by controlling the strength of the first pump 52.

Next, when the stack inlet temperature satisfies the target temperature, a cathode inlet temperature is measured through the cathode inlet temperature sensor 44. As the result of the measurement, when the cathode inlet temperature differs from the target temperature, the flow rate of the cooling water flowing into the membrane humidifier is controlled by controlling the opening and closing amounts of the cooling water control valve 56.

Next, when the cathode inlet temperature of the stack satisfies the target temperature, the operation voltage of the stack is measured through the voltage monitoring device 12. As the result of the measurement, when the operation voltage of the stack differs from a target value, the flow rate of the cooling water flowing into the membrane humidifier is controlled by controlling the opening and closing amounts of the cooling water control valve 56.

In summary, to control the humidification amount of the cathode gas (air), if the inlet temperature of the fuel cell stack 10 is out of the target temperature range, the controller 60 can adjust the flow rate of the cooling water entering the fuel cell stack 10 by controlling the strength of the first pump 52; if the inlet temperature of the cathode is out of the target temperature range, the controller 60 can adjust the flow rate of the cooling water entering the membrane humidifier 40 by adjusting the opening and closing amounts of the cooling water control valve 56; and if the operating voltage of the fuel cell stack 10 is out of the target value, the controller 60 can adjust the flow rate of the cooling water entering the membrane humidifier 40 by adjusting the opening and closing amounts of the cooling water control valve 56.

Accordingly, the humidification amount of the cathode gas can be effectively controlled.

In the fuel cell system according to the present invention, real time humidification of the anode gas can be carried out as follows.

First, a stack inlet temperature is measured through the cooling water inlet temperature sensor 57. As the result of the measurement, when the stack inlet temperature differs from a target temperature, the flow rate of the cooling water flowing into the fuel cell stack 10 is controlled by controlling the strength of the first pump 52.

Next, when the stack inlet temperature satisfies the target temperature, the operation temperature of the selective oxidation reactor 30 is measured through the selective oxidation reactor temperature sensor 32. As the result of the measurement, when the operation temperature of the selective oxidation reactor 30 differs from a target temperature, the flow rate of the cooling water flowing into the selective oxidation reactor 30 is controlled by controlling the strength of the second pump 54. In this case, the target operation temperature of the selective oxidation reactor may range from 90 to 130 °C but is not limited thereto.

Next, when the operation temperature of the selective oxidation reactor satisfies the target temperature, an anode inlet temperature is measured. As the result of the measurement, when the anode inlet temperature differs from a target temperature, the flow rate of the cooling water flowing into the selective oxidation reactor 30 is controlled by controlling the strength of the second pump 54. In this case, the target anode inlet temperature may range from 60 to 70 °C but is not limited thereto.

Next, when the anode inlet temperature satisfies the target temperature, the operation voltage of the stack is measured through the voltage monitoring device 12. As the result of the measurement, when the operation temperature of the stack differs from the target value, the flow rate of the cooling water flowing into the selective oxidation reactor 30 is controlled by controlling the strength of the second pump 54.

In summary, to control the humidification amount of the anode gas (hydrogen-containing gas), if the inlet temperature of the fuel cell stack 10 is out of the target temperature range, the controller 60 can adjust the flow rate of the cooling water entering the fuel cell stack 10 by controlling the strength of the first pump 52; if the operating temperature of the selective oxidation reactor 30 is out of the target temperature range, the controller 60 can adjust the flow rate of the cooling water entering the selective oxidation reactor 30 by controlling the strength of the second pump 54; if the inlet temperature of the anode is out of the target temperature range, the controller 60 can also adjust the flow rate of the cooling water entering the selective oxidation reactor 30 by controlling the strength of the second pump 54; and if the operating voltage of the fuel cell stack 10 is out of the target value, the controller 60 can control the flow rate of the cooling water entering the selective oxidation reactor 30 by controlling the strength of the second pump 54.

Accordingly, the humidification amount of the anode gas can be effectively controlled.

According to the present invention, by controlling the amount of humidification of reaction gas in real time during operation of a fuel cell system, it is possible to effectively prevent degradation of the performance of a fuel cell stack or shortening of the lifetime of a polymer electrolyte membrane, which can occur when there is too little moisture in the polymer electrolyte membrane, and effectively prevent a decrease in a response speed or fluctuation of a fuel cell output, which can occur when there is too much moisture in the polymer electrolyte membrane.

It should be understood that the effects of an aspect of the present invention are not limited to the above effects and include all effects inferable from the configuration described in the detailed description or claims of the invention of the present specification.

The above description of the present specification is illustrative, and those skilled in the art to which an aspect of the present specification pertains will be able to understand that the present invention may be easily modified into other specific forms without changing the technical spirit or essential features described in the present specification. Accordingly, it should be understood that the above-described embodiments are illustrative and not restrictive in all aspects. For example, each component described in a singular form may be implemented separately, and likewise, components described as being implemented separately may also be implemented in a combined form.

The scope of the present specification is defined by the appended claims, and all changes or modifications derived from the meaning and scope of the claims and equivalent concepts thereof should be construed as being included in the scope of the present specification.

[Reference Numeral]

| | |
|---|---|
| 100: fuel cell system | 10: fuel cell stack |
| 12: voltage monitoring device | 20: reformer |
| 30: selective oxidation reactor | 32: elective oxidation reactor temperature sensor |
| 34: anode temperature inlet sensor | 40: membrane humidifier |
| 42: air pump | 44: cathode inlet temperature sensor |
| 50: cooling water tank | 52: first pump |
| 54: second pump | 56: cooling water control valve |
| 57: cooling water inlet temperature sensor | 58: cooling water outlet temperature sensor |
| 60: controller | 70: heat exchanger |
| 72: heat collecting device | 80: inverter |

What is claimed is:

1. A fuel cell system comprising:
a fuel cell stack which generates power by an electrochemical reaction of hydrogen contained in hydrogen-containing gas and oxygen contained in air and is cooled by cooling water;
a reformer configured to react a hydrocarbon-based raw material with water vapor to generate reformed gas;
a selective oxidation reactor which removes carbon monoxide from the reformed gas to generate the hydrogen-containing gas and is cooled by cooling water;
a membrane humidifier configured to receive at least some cooling water discharged from the fuel cell stack and humidify air supplied to the fuel cell stack;
a cooling water tank configured to store the cooling water; and
a controller configured to control humidification amounts of the hydrogen-containing gas and the air, which are supplied to the fuel cell stack.

2. The fuel cell system of claim 1, further comprising:
a first pump configured to control a supply amount of cooling water supplied to the fuel cell stack; and
a second pump configured to control a supply amount of cooling water supplied to the selective oxidation reactor.

3. The fuel cell system of claim 1, further comprising a cooling water control valve configured to control a supply amount of cooling water supplied to the membrane humidifier from cooling water discharged from the fuel cell stack.

4. The fuel cell system of claim 1, wherein the controller controls the humidification amount of the hydrogen-containing gas by controlling a supply amount of cooling water supplied to the selective oxidation reactor.

5. The fuel cell system of claim 4, wherein the controller controls the supply amount of the cooling water supplied to the selective oxidation reactor so that an operation temperature of the selective oxidation reactor ranges from 90 to 130 °C and a temperature of the hydrogen-containing gas supplied to the fuel cell stack ranges from 60 to 70 °C.
